(19) United States
(12) Patent Application Publication
(10) Pub. No.: US 2026/0293905 A1
(43) Pub. Date: Oct. 1, 2026

(54) SEED OR ROOT TREATMENT COMPOSITION COMPRISING MOLYBDATE AND MICROBES AND USE THEREOF IN PLANTS

(71) Applicant: Croda International Plc, Goole, Yorkshire (GB)

(72) Inventors: Steven Robert ADAMS, Goole, Yorkshire (GB); Andrew Mark FOWLES, Goole, Yorkshire (GB)

(73) Assignee: Croda International Plc, Goole, Yorkshire (GB)

(21) Appl. No.: 19/480,580

(22) PCT Filed: Apr. 22, 2024
(86) PCT No.: PCT/EP2024/060951

§ 371 Date: Oct. 31, 2025

(30) Foreign Application Priority Data
May 2, 2023 (GB) 2306474.4

(51) Int. Cl. A01N 59/16; A01N 63/20; A01P 21/00

(52) U.S. Cl. CPC A01N 59/16; A01N 63/20; A01P 21/00

(57) ABSTRACT

The present invention relates to a seed treatment composition and root treatment composition which may be applied to seed, soil, or plant. The composition comprises inorganic molybdenum compound which is selected from potassium molybdate, magnesium molybdate, or calcium molybdate, as well as one or more microbe which may be a plant growth microbe such as diazotrophic bacteria. There is also provided a seed coated with said seed treatment composition. The use of the said inorganic molybdates provides biostimulant effects to the seed or plant, and is found to be combinable with a microbe with limited or no toxicity effect, especially when in a long life storage environment prior to use.

### CROSS REFERENCE TO RELATED APPLICATIONS

This application is the U.S. National Phase of PCT International Application No. PCT/EP2024/060951, filed Apr. 22, 2024, which claims priority to Great Britain Patent Application No. 2306474.4, filed May 2, 2023, the contents of these applications being incorporated by reference herein in their entireties for all purposes.

### FIELD OF THE INVENTION

The present invention relates to a seed treatment composition. The seed treatment composition as described herein provides utility as a fertiliser for agricultural crops. More especially some embodiments provide a seed coated with said seed treatment composition, and/or are particularly suitable for use in methods of enhancing plant growth or crop production.

### BACKGROUND OF THE INVENTION

Seeds are often treated, typically by coating, to provide useful substances (active ingredients) to the seed and the seedlings upon germination, for example, plant nutrients, growth stimulating agents, and plant protective products. Plant seed is also often coated before sowing, for example, to protect seeds from damage during handling and/or to improve handling properties.

The present invention relates in general to a fertiliser composition that can be used in agriculture to promote or enhance growth of cultivated plants, and therefore their production yield. Optionally, biostimulants may be utilised in fertiliser products, or used as alternative standalone products. In general terms the use of biostimulants looks to increase plant productivity, reduce the impact of abiotic stress, and decrease the demand for fertilisers; it is well known that an excessive and indiscriminate use of plant nutrients in fertilisers can cause environmental damages, such as eutrophication of the surface water and groundwater pollution. Known biostimulants may enhance metabolic or physiological processes such as respiration, photosynthesis, nucleic acid uptake, ion uptake, nutrient delivery, or a combination thereof.

Plant growth promoting microbes include bacteria and fungi that can enhance plant growth and/or protect plants from disease and stress, they can act through a variety of mechanisms, as such, suitable inoculants can contribute to increased agronomic efficiency and facilitate reduced use of chemical fertilisers. Rhizobia are an example of a plant promoting diazotrophic bacteria that fix nitrogen after becoming established inside the root nodules of plants of the Fabaceae family, although alternative gram negative bacteria, such as Herbaspirillum sp. are also known to fix nitrogen in important agricultural crops such as maize, rice, and sugar cane In some crops molybdenum (Mo) and cobalt (Co) are considered essential nutrients for nodulation and nitrogen fixation. However, Mo and Co salts and compounds can be very toxic to microbes, and so adversely affect the time treated seed can be stored before sowing. Seeds with a long shelf life (i.e. the time they are stored prior to sowing) which have been treated with plant growth promoting microbes and Mo and/or Co where the viability of the microbe on the treated seed is not lost or overtly degraded are sought.

Seed establishment rates in flooded conditions utilising molybdenum containing compounds has been well studied and as reported by Y. Hara et al, in Plant Production Science (2017), 20(4), 406-411 a comparison of tungsten and molybdenum (Mo) containing compounds as seed treatments for rice seeds is considered. Therein, it is reported that no improvements in seed establishment are observed when sodium molybdate, potassium molybdate, or calcium molybdate are applied to seeds with water, and treatment rates employed were 0.2 mole Mo per kilogram (Kg) of rice seed, equivalent to 19.2 g Mo per Kg rice seed.

Surprisingly, the current inventors have found that use of some inorganic molybdenum compounds in combination with plant growth promoting microbes may be provided to plants without unacceptable toxicity to the microbe.

### SUMMARY OF THE INVENTION

According to the present invention there is provided a seed treatment composition comprising at least one inorganic molybdenum compound selected from potassium molybdate, magnesium molybdate and calcium molybdate, and one or more microbe.

There is also provided a seed coated with a seed treatment composition comprising at least one inorganic molybdenum compound and one or more microbe as described herein.

Furthermore, there is provided a root treatment composition comprising at least one inorganic molybdenum compound and one or more microbe as described herein. Additionally, there is provided use of a seed treatment composition or root treatment composition comprising at least one inorganic molybdenum compound and one or more microbe as described herein in a method of enhancing plant growth or crop production comprising applying said seed treatment composition or root treatment composition to a seed, soil, or a plant. The seed treatment composition may be added to the seed as an in-furrow application where the seed and one or more treatment components are added to the furrow at the same time.

### DETAILED DESCRIPTION OF THE INVENTION

As used herein, the terms “for example,” “for instance,” “such as,” or “including” are meant to introduce examples that further clarify more general subject matter. Unless otherwise specified, these examples are provided only as an aid for understanding the applications illustrated in the present disclosure, and are not meant to be limiting in any fashion.

The term “seed” as used in this application is meant to refer in particular to the ripened ovule of gymnosperms and angiosperms, which contain an embryo surrounded by a protective cover. In particular, the term covers field crop seeds, vegetable seeds, and cereal kernels.

The protective cover can comprise the seed coat (testa). Some seeds comprise a pericarp or fruit coat around the seed coat. As used in this application, the term “seed coat” is meant to include a caryopsis or an achene. The term “seed” includes anything that can be planted in agriculture to produce plants, including pelleted seeds, true seeds, plant seedlings, rootstock, regenerable and plant forming tissue, and tubers or bulbs.

The term “coating” as used in this application, is meant to refer to applying material to a surface of a seed, for instance as a continuous or discontinuous layer of a material around a seed. Coating methods includes film coating, pelleting, and encrusting or a combination of these techniques as is known in the art. The coating is preferably applied over substantially the entire surface of the seed, such as over 90% or more of the surface area of the seed, to form a layer. However, the coating may be complete or partial, for instance over 20% or more of the surface area of the seed, or 50% or more.

The term “seed treatment composition” as used in this application is meant to refer to a composition to be used in combination with a seed. The seed treatment may or may not be provided to a seed as a seed coating as described above. The term “root treatment composition” as used in this application is meant to refer to a composition to be used for application to a plants root or a rootstock, prior to or after planting. The root treatment composition may or may not be applied to a plant root or rootstock as a coating, analogous to the seed coating described above, misted on to roots, or watered into soil and thereby brought into contact with plant roots in situ by conventional on farm methods.

When used herein, it will be understood that the term “wt %” refers to the percentage by weight of the specified component on the basis of the total weight of the specified entity which the component is part of.

As such, in accordance with one embodiment of the present invention there is provided a seed treatment composition comprising at least one inorganic molybdenum compound and one or more microbe.

Generally, the seed treatment composition comprises at least one inorganic molybdenum compound selected from an alkali inorganic molybdenum compound and an alkali earth inorganic molybdenum compound, but more preferably the seed treatment composition comprises at least one inorganic molybdenum compound selected from potassium molybdate, magnesium molybdate and calcium molybdate, even more preferably at least one inorganic molybdenum compound selected from magnesium molybdate and calcium molybdate, and most preferably the seed treatment composition comprises calcium molybdate. The seed treatment composition comprises between 0.1 wt % and 80 wt % molybdenum, more preferably between 1 wt % and 50 wt %, and most preferably between 5 wt % and 30 wt %.

The seed treatment composition comprises one or more microbe, preferable one or more plant growth promoting microbe. Said one or more plant growth promoting microbe may be a bacteria or fungi. More preferably the seed treatment composition comprises a plant growth promoting bacteria, examples of suitable plant growth promoting microbes are described in “Souza Rd, Ambrosini A, Passaglia L M. Plant growth-promoting bacteria as inoculants in agricultural soils. Genet Mol Biol. 2015 December; 38(4):401-19. doi: 10.1590/S1415-475738420150053. Epub 2015 Nov. 3. PMID: 26537605; PMCID: PMC4763327” although, more especially is a plant growth-promoting bacteria with the ability to fix nitrogen. Most preferably the seed treatment composition comprises a plant growth promoting diazotrophic bacteria, and desirably said diazotrophic bacteria is a rhizobacteria (rhizobia) and/or azospirillum, more preferably the diazotrophic bacteria is a rhizobacteria known to be beneficial in increasing nodule number in legumes such as soybeans enhancing nitrogen fixation and having a positive affect on plant growth and crop yield, most preferably the seed treatment composition comprises Bradyrhizobium elkanii or Bradyrhizobium japonicum or a mixture of both. Inoculant bacteria are known to the person skilled in the art and may be selected as most appropriate for the seed or plant type to be treated. More especially, the diazotrophic bacteria may be provided by a suitable commercially available inoculant product such as, for example, those available under the brand name Nitragin® ex. Novozymes which contain bacteria from the genus Bradyrhizobium. However, for the avoidance of doubt, the provision of diazotrophic bacteria to other plant types beyond e.g. legumes is contemplated as such alternative bacterial inoculants may help to control plant diseases that are caused by other harmful bacteria and fungi, as such, further examples of suitable commercially available inoculant products include: AZOSPIRILLUM ex. Peptech Bioscience Ltd, MASTERfix Gramineas ex. Stoller Enterprises, Inc, AzoMax ex. Novozymes, Rizospirillum ex. Rizobacter, and AZOTROP ex. Biotrop. Suitably, the inclusion rate ratio of bacteria inoculum relative to the further components of the seed treatment composition is in the range 10:1 to 1:10.

As alluded to above, the seed treatment composition may comprise more than one plant growth promoting microbe. More especially, the composition may comprise the preferred diazotrophic bacteria as described above and a further plant growth promoting microbe of a different type; as such the composition comprises two differing plant growth promoting microbe and may preferably be provided by a suitable commercially available inoculant such as, for example, those available under the brand name TagTeam® ex. Bayer which contain a plant growth-promoting rhizobacteria in combination with phosphate-solubilizing microbe Penicillium bilaiae.

Additionally, the seed treatment composition preferably comprises water, such that the composition is an aqueous composition. Preferably the seed treatment composition comprises between 25 wt % to 85 wt % water. The water acts as a diluent and allows the formation of an aqueous suspension which provides the at least one inorganic molybdenum compound in a convenient form for application to a seed or rootstock. The diazotrophic bacteria are coapplied at time of treatment or in furrow application. The presence of water also allows for ease of handling and further dilution of the product, for example, for application to soil, seeds or plants in situ for on farm treatment. Additionally, the seed treatment composition preferably comprises cobalt. In addition to molybdenum, cobalt is also considered an essential nutrient for nodulation and nitrogen fixation in some plants. As such, the seed treatment composition may preferably comprise a cobalt salt or compound, more preferably the seed treatment composition comprises a cobalt salt or compound selected from or more of the following: cobalt (II) oxide, tricobalt tetraoxide (cobalt (II,III) oxide), cobalt nitrate hexahydrate, and cobalt sulphate heptahydrate. Most preferably the seed treatment composition comprises tricobalt tetraoxide. The seed treatment composition comprises between 0.01 wt % and 80 wt % cobalt, more preferably 0.1 wt % and 20 wt %, and most preferably 0.5 wt % and 3 wt %.

Optionally, the seed treatment composition may comprise a binder. Preferably, when present, the seed treatment composition may comprise up to 40 wt % binder. Suitable binders may be polymers or copolymers. In one embodiment, the binder may be a polymeric binder as described in PCT international publication number WO2017/081535 (incorporated herein by reference), and in this case the polymeric binder is selected from the group consisting of polyvinyl acetates, polyvinyl acetate copolymers, polyvinyl alcohols, polyvinyl alcohol copolymers, polyurethane, celluloses (including ethylcelluloses, methylcelluloses, hydroxymethylcelluloses, hydroxypropylcelluloses, carboxymethylcelluloses, and hydroxymethylpropyl celluloses), polyvinylpyrrolidones, dextrins, maltodextrins, starchs, polysaccharides, fats, oils, proteins, gum arabics, shellacs, vinylidene chloride, vinylidene chloride copolymers, calcium lignosulphonates, polyacrylates, acrylic copolymers, polyvinylacrylates, zeins, casein, gelatine, chitosan, pullulan, polyethylene oxide, polyethylene glycol, acrylamide polymers, acrylamide copolymers, polyhydroxyethyl acrylate, methylacrylamide polymers, poly(N vinylacetamide), sodium alginate, polychloroprene, and syrups, as described therein. The presence of a binder assists in the adhesion of the active ingredients of the seed treatment composition to a coated seed, as well as providing anti-dusting and ease of handling properties to a coated seed product.

Additionally, the seed treatment composition may comprise a dispersant, such as sulphonated naphthalene formaldehyde condensates and acrylic copolymers such as the comb copolymer having capped polyethylene glycol side chains on a polyacrylic backbone.

Atlox® PN-100 (ex. Croda) is a particularly suitable polymeric dispersant as it facilitates high concentrations of inorganic solids in water, and has a long shelf life. Preferably the seed treatment composition may contain a dispersant between 0.5 wt % and 10 wt %. Additionally, the seed treatment composition may comprise a wetting agent, such as alcohol ethoxylate and alcohol ethoxylate/propoxylate. Preferably, the seed treatment composition may comprise between 0 wt % and 5 wt % of a wetting agent.

Additionally, the seed treatment composition may comprise an antifoaming agent, Preferably the seed treatment composition comprises between 0.005 wt % to 10 wt % antifoaming agent, more preferably 0.1 wt % to 0.3 wt % antifoaming agent. Suitable antifoaming agents include polyethylene glycol, glycerine, mineral oil defoamers, silicone defoamers, and non-silicone defoamers (such as polyethers, polyacrylates), dimethylpolysiloxanes (silicone oils), arylalkyl modified polysiloxanes, and polyether siloxane copolymer containing fumed silica.

Additionally, the seed treatment composition may comprise a viscosity modifier, such as commercially available water soluble or miscible gums, for example xanthan gums, and/or cellulosics, for example carboxy-methyl, ethyl or propylcellulose. Preferably the viscosity modifier is a xanthan gum as these provide desirable shear thinning properties, resulting in a high viscosity, gelled composition under a no or low shear environment and a low viscosity, high flow composition under a high shear environment such as when poured or pumped; this provides handling benefits to the composition when in use. Preferably the seed treatment composition comprises between 0.01 wt % to 2 wt % viscosity modifier.

Additionally, the seed treatment composition may comprise diluents, absorbents or carriers such as carbon black; talc; diatomaceous earth; kaolin; aluminium, calcium or magnesium stearate; sodium tripolyphosphate; sodium tetraborate; sodium sulphate; sodium, aluminium and mixed sodium-aluminium silicates; and sodium benzoate.

Preferably the seed treatment composition is free from antimicrobial agents and/or biocides.

Such materials are commonly included in seed treatment compositions, but in the present case may have a detrimental effect upon the microbe necessarily present in particular having an adverse effect upon the microbe longevity in the composition which may reduce shelf life and hasten the time required to sow treated seeds in use. As such, the seed treatment composition of the present invention preferably does not include an antimicrobial agent or biocide. Alternatively, the antimicrobial agent and/or biocide may be selected to have minimal effect upon the microbe present in the seed treatment composition, but where the antimicrobial agent and/or biocide has selectivity for pathogenic or deleterious microbes. Additionally or alternatively, there is also provided a seed coated with the seed treatment composition comprising at least one inorganic molybdenum compound and a microbe as described above. In the case of such a coated seed product, any water present in the seed treatment composition as described above will be substantially removed by curing, drying or evaporating during the seed coating process. Residual amounts of water may, however, be retained in the seed coating matrix.

The seed coated with the seed treatment composition is a plant seed, for example a seed of an agricultural or field crop, a vegetable seed, an herb seed, a wildflower seed, an ornamental seed, a grass seed, a tree seed, or a bush seed.

Suitably, the plant seed is of an agricultural crop. Suitable plant seeds include seed of soybean, cotton, corn, peanut, maize, wheat, barley, oat, rye triticale, mustard, oil seed rape (or canola) sunflower, sugar beet, safflower, millet, chicory, flax, rapeseed, buckwheat, tobacco, hemp seed, alfalfa, signal grass, clover, sorghum, chickpea, beans, peas, vetch, rice, sugar cane, guayule, and linseed. Examples of suitable vegetable seeds include asparagus, chives, celery, leek, garlic, beetroot, spinach, beet, curly kale, cauliflower, sprouting broccoli, savoy cabbage, white cabbage, red cabbage, kohlrabi, Chinese cabbage, turnip, endive, chicory, watermelon, melon, cucumber, gherkin, marrow, parsley, fennel, pea, beans, radish, black salsify, eggplant, sweet corn, pop-corn, carrot, onion, tomato, pepper, lettuce, snap bean, cucurbit, shallot, broccoli, Brassica, and Brussels sprout. More especially, the seed may be of the order of Fabales, and the plant seed may preferably be selected from the family of Fabaceae, commonly known as the legume family.

More preferably, the plant seed is soybean, chickpea, pea, or alfalfa, and most preferably is soybean.

Preferably, the plant seed is capable of germinating. Optionally, the seed may be deprived of husk (a so called husked seed or de hulled seed). The seed may be primed or not primed (having been subjected to a treatment to improve the germination rate, e.g. osmopriming, hydropriming, matrix priming).

The seed treatment composition of the present invention may be applied to the seed in any conventional manner, preferably by coating utilising coating techniques as known in the art.

It is envisaged that the present invention applies to all said coating types. A suitable coating composition of the present invention can be prepared by diluting (preferably in water) and forming into a slurry with the other optional components of the seed treatment composition added in order to make the seed coating composition which is then applied to the seeds. The order of addition of the components of the composition is not essential to performance of the invention.

Preferably, the seed treatment composition is applied as a liquid composition and/or emulsion and/or dispersion and/or latex composition and thereafter solidified (including cured and/or dried) to form a seed coating. The term ‘liquid coating composition’ as used in this application is meant to include coating compositions in the form of a suspension, emulsion, and/or dispersion, preferably a dispersion.

Conventional means of coating may be employed for coating the seeds with the seed treatment composition. Various coating machines are available to the person skilled in the art. Some well-known techniques include the use of drum coaters, fluidised bed techniques, rotary coaters (with and without integrated drying), and spouted beds. Suitably, the seed treatment composition is applied to the seed by a rotary coater, a rotary dry coater, a pan coater or a continuous treater.

Typically, the amount of seed treatment composition applied to the seed can be in the range of 0.05 to 20 mL per per kg seed, preferably 0.1 to 7.5 mL per kg seed, more preferably 0.5 to 1.5 mL per kg seed.

Seed coating typically involves forming on the surface of the seeds a firmly adhering, moisture permeable coating. The process typically comprises applying a liquid seed coating composition to the seeds before planting, as such, the seed treatment composition as described above preferably comprises water.

An additional film coat layer may optionally be applied over the top of the seed treatment composition coating layer of the invention to provide additional benefits, including but not limited to cosmetics, coverage, actives, nutrients, and processing improvements such as faster drying, seed flow, durability and the like.

Furthermore, there is provided a root treatment composition comprising at least one inorganic molybdenum compound and a diazotrophic bacteria as described herein. The root treatment composition can be considered to be composed of a seed treatment composition as described above, but its method of application in use is distinguished i.e. the root treatment composition is applied directly to the roots of a plant that has already germinated, and may be applied as a treatment directly to an unplanted root stock, or introduced to the roots of a more established plant in situ by conventional on farm methods, such as via watering in via a conventional irrigation system.

As described above, the seed treatment composition may comprise diluents, absorbents or carriers such as carbon black; talc; diatomaceous earth; kaolin; aluminium, calcium or magnesium stearate; sodium tripolyphosphate; sodium tetraborate; sodium sulphate; sodium, aluminium and mixed sodium-aluminium silicates; and sodium benzoate. In inclusion of such diluents, absorbents or carriers is particularly preferred in a root treatment composition which is designed to be directly applied to rootstock, and where no water, or minimal water is present in the composition. However, misting of roots with the treatment composition is contemplated, and in this case the presence of water would be desirable.

Additionally, there is provided use of a seed treatment composition or root treatment composition comprising inorganic molybdenum compound and a diazotrophic bacteria as described herein in a method of enhancing plant growth or crop production comprising applying said seed treatment composition or root treatment composition to a seed, soil, or a plant. In such a method the seed treatment composition or root treatment composition comprising inorganic molybdenum compound and a diazotrophic bacteria is applied to, or brought into direct contact with, a part of a plant, including the seed, roots, or soil via seed coating, root misting or coating, or in situ on farm watering. Foliar application of said seed treatment composition or root treatment composition comprising at least one inorganic molybdenum compound and a diazotrophic bacteria is possible, but less preferred as the bacteria preferably used in the present invention provides root nitrogen uptake, however it is envisaged that alternative bacteria may be beneficially provided to the leaves of a plant in accordance with the present invention in particular where microbial disease prevention may be a desirable outcome.

The present invention will now be described with reference to the following examples.

### Materials

Materials utilised are as follows:
Sterile hard water
Water
Deionised water
Molybdenum trioxide ex. Molekula
Calcium molybdate ex. Molekula
Ammonium molybdate ex. Sigma-Aldrich
Sodium molybdate ex. Sigma-Aldrich
Tricobalt tetraoxide ex. Molekula
Cobalt nitrate hexahydrate ex. Sigma-Aldrich
Cobalt sulphate heptahydrate ex. Sigma-Aldrich
Monoethanolamine molybdate (prepared from molybdenum trioxide and
monoethanolamine)
Molybdenum trioxide ex. Molekula, monoethanolamine ex. Sigma-Aldrich
Atlox PN100 ex. Croda.
Atlox 4991 ex. Croda.
Kelzan AP-AS ex. CP Kelco
Avicel CL611 ex. FMC corporation
Nitragin Optimise—containing a mix of Bradyrhizobium japonicum, Bj, and B. elkani (strains: 5019 & 5079) ex. Novozymes
Nitragin Biopower ex. Novozymes
Untreated soybean seed (cv. Naya) ex. Soya UK (Lab no. S2109, Lot no. 4-2073-00701-01)

### EXAMPLES

### Example 1: In Vitro Screening of Molybdenum Compounds

As molybdenum and cobalt containing materials are known to be toxic to rhizobia initial in vitro screening was undertaken so that compounds exhibiting high toxicity to a commercially available rhizobia containing inoculum (Nitragin Optimize) could be excluded from further screening.

### Study 1 and Study 2

This initial screening was performed in two parts: Study 1 and Study 2. Study 1 compared molybdenum salts/compounds against the inoculum. Study 2 compared formulated molybdenum compounds/salts against the inoculum as well as cobalt compounds/salts.

A range of molybdenum salts (molybdenum trioxide, calcium molybdate, ammonium molybdate, sodium molybdate) were compared to assess their effect on rhizobia survival. Similarly, a range of cobalt salts were compared (tricobalt tetraoxide, cobalt nitrate hexahydrate and cobalt sulphate heptahydrate). All of these salts were added to sterile hard water. In addition to this, four molybdenum salts were formulated into sample compositions and were tested in Study 2; details of these sample compositions are as follows:

Calcium molybdate composition

| | Concentration |
|---|---|
| Component | (% wt/wt) |
| Calcium molybdate | 40.00 |
| Atlox PN100 | 5.00 |
| Atlox 4991 | 2.00 |
| Kelzan AP-AS | 0.015 |
| Avicel CL611 | 0.50 |
| Water | 52.485 |
| Total | 100 |
| concentration (%) | |

Sodium molybdate composition

| | Concentration |
|---|---|
| Component | (% wt/wt) |
| Sodium molybdate | 30.00 |
| Kelzan AP-AS | 1.00 |
| Water (deionised) | 69.00 |
| Total | 100 |
| concentration (%) | |

Ammonium molybdate composition

| | Concentration |
|---|---|
| Component | (% wt/wt) |
| Ammonium molybdate | 15.00 |
| tetrahydrate | |
| Kelzan AP-AS | 1.00 |
| Water (deionised) | 84.00 |
| Total | 100 |
| concentration (%) | |

Monoethanolamine
molybdate solution

| | Concentration |
|---|---|
| Component | (% wt/wt) |
| Molybdenum trioxide | 37.11 |
| Monoethanolamine | 21.14 |
| Water (deionised) | 41.75 |
| Total | 100 |
| concentration (%) | |

In both Study 1 and Study 2, the rhizobia containing inoculum was provided by a previously un-opened, recent batch of Nitragin Optimise. The inoculum was diluted in sterile hard water by five times (5×) to provide the final test concentration. Test samples were prepared at 1.25× final test concentration in 10 mL sterile hard water in a sterile Universal bottle.

The test method was based on the principles of biocide testing contained in ISO standards (BSI 1997) modified as appropriate to the target organism and described as follows: The initial dilution of each test material was made into a UQA (universal quenching agent) (Lambert, Johnston & Simons 1998), subsequent dilutions were in 0.1% peptone. Sterile hard water was freshly prepared and sterilised by filtration.

All materials and samples tested had their weights normalised to give the same Molybdenum (Mo) or Cobalt (Co) concentration in the test solutions; 136 grams per litre of Mo was utilised in Study 1, and 80 grams per litre of Mo and 20 grams per litre of Co was utilised in Study 2.

An inoculum stock dilution was prepared to give a target bacteria concentration of 1.5×10⁶ CFU/mL. —this was a 5× dilution of commercial Nitragin inoculum with sterile hard water.

The appropriate amount of the test formulations (for a final test mix of 12.5 mL) were added to suitable test bottles and 2.5 mL of the inoculum stock was added to each bottle.

A balance of sterile hard water was added to each bottle to give a final test mix volume of 12.5 mL.

Test solutions were then left to stand at room temperature for 20 mins, then vortexed and a 0.5 mL sample withdrawn and diluted in UQA. Samples were left in contact with UQA for at least 5 min, before a further series of tenfold dilutions was prepared in sterile 0.1% peptone. Dilutions were plated on plates of yeast mannitol agar (YMA), using the drop method of Miles and Misra (Miles & Misra 1933) with 3 or 4 replicate drops at each dilution. Plates were then incubated at 27° C. for up to 14 d and the number of typical Bradyrhizobium colonies in each drop at each dilution recorded. Dilution and plating was also repeated after a further time had elapsed at either four hours (4 h) or twenty four hours (24 h).

Calcium molybdate and ammonium molybdate both showed good rhizobia compatibility in vitro. Sodium molybdate, and monoethanolamine molybdate provided reasonable, commercially acceptable compatibility. Observed toxicity to the rhizobia was greatest for the Molybdenum trioxide sample in Study 1.

In terms of the cobalt salts in Study 2, tricobalt tetraoxide showed the best compatibility with rhizobia.

TABLE 1
Results from Study 1 comparison
of different molybdenum salts/
compounds in vitro.

| | Bacterial numbers | |
|---|---|---|
| | log₁₀(CFU/mL) | |
| | and exposure time | |
| Test Sample | 30 mins | 4.5 hours |
| Nitragin Optimize | 5.64 | 5.98 |
| (control) | | |
| Molybdenum trioxide | <2 | <2 |
| Calcium molybdate | 5.68 | 5.89 |
| Ammonium molybdate | 5.85 | 5.98 |
| Sodium molybdate | 5.71 | 5.81 |

TABLE 2
Results from Study 2 comparison of
seed treatment compositions including
molybdenum salts/compounds and
cobalt salts/compounds in vitro.

| | Bacterial numbers | |
|---|---|---|
| | log₁₀(CFU/mL) | |
| | and exposure time | |
| Test composition/salt | 30 mins | 24 hours |
| Nitragin Optimize | 6.75 | 6.79 |
| (control) | | |
| Calcium molybdate | 6.50 | 6.26 |
| 40% SC | | |
| Sodium molybdate gel | 6.56 | 5.99 |
| Ammonium molybdate | 6.56 | 6.23 |
| gel | | |
| Monoethanolamine | 6.56 | 4.52 |
| molybdate solution | | |
| Tricobalt tetraoxide | 6.70 | 6.53 |
| Cobalt nitrate | 6.57 | <2 |
| hexahydrate | | |
| Cobalt sulphate | 6.06 | <2 |
| heptahydrate | | |

### Example 2: In Vivo Screening to Assess the Viability of Rhizobia on Seed Treated with Seed Treatment Compositions and Comparative Compositions

Based on the results from the in vitro data from the two studies described above the better performing molybdenum and cobalt salts/compounds were formulated to assess their effect on rhizobia compatibility/toxicity when applied on to seed.

The inoculum used was Nitragin Optimise, except for in the case of Study 5 which utilised Nitragin Biopower. Untreated soybean seed was pre-weighed into aliquots of 333 grams in over-size grip-seal polythene bags. A 1 mL aliquot of inoculum was added directly to each bag with a sterile pipette, and immediately the bag was shaken to mix. The requisite volume of sample composition was then added to each bag using a sterile pipette. Following addition of sample bags were immediately shaken to distribute sample over the seeds. The seeds are thus provided with a coating of a seed treatment composition in accordance with the present invention comprising both a relevant inorganic molybdate and rhizobia, or the seeds are provided with a comparative seed treatment comprising samples and rhizobia but not forming compositions in accordance with the present invention. The bags of treated seed were then left open in the air flow of a fan at room temperature until the first sampling (24 hours later). Following the first sampling bags were closed and maintained at room temperature in the laboratory. A temperature logger, recording at 30 min intervals, was placed amongst the bags of seed.

At 24 hours after initial treatment, and then at each subsequent sampling time, a sub-sample of each seed aliquot (43 grams or approximately 200 seeds) was weighed out into a sterile conical flask, and 100 mL of extraction medium (sterile saline plus 0.02% Tween) added. Flasks were then shaken for 30 min on an orbital shaker, a series of tenfold dilutions prepared in sterile saline, and 0.1 mL spread on plates on YMA+natamycin (a fungicide) medium. Plates were incubated for up to 14 days at 27° C. and the numbers of typical Bradyrhizobium colonies counted.

A single sub-sample of each seed aliquot was tested at 1, 4, 8, 18 and 43 days after inoculation and treatment.

### Study 3

In this study four samples were applied to the seed along with rhizobium (1 mL inoculum per 333 g seed). A calcium molybdate composition in the form of a solution was compared to three alterative compositions (ammonium molybdate, sodium molybdate and monoethanolamine molybdate) in the form of gels that also contained cobalt oxide. The composition of each formulation included in the treatment list for Study 3 (Table 3) is described below:

Calcium molybdate seed
treatment composition

| | Concentration |
|---|---|
| Component | (% wt/wt) |
| Calcium molybdate | 40.00 |
| Atlox PN100 | 5.00 |
| Atlox 4991 | 2.00 |
| Kelzan AP-AS | 0.015 |
| Avicel CL611 | 0.50 |
| Water | 52.485 |
| Total | 100 |
| concentration (%) | |

Ammonium molybdate
and Cobalt Oxide seed
treatment composition

| | Concentration |
|---|---|
| Component | (% wt/wt) |
| Ammonium | 15.00 |
| molybdate | |
| tetrahydrate | |
| Cobalt oxide | 1.11 |
| Kelzan AP-AS | 1.00 |
| Water (deionised) | 82.89 |
| Total | 100 |
| concentration (%) | |

Sodium molybdate +
Cobalt Oxide seed
treatment composition

| | Concentration |
|---|---|
| Component | (% wt/wt) |
| Sodium molybdate | 30.00 |
| Cobalt oxide | 1.42 |
| Kelzan AP-AS | 1.00 |
| Water (deionised) | 67.58 |
| Total | 100 |
| concentration (%) | |

Monoethanolamine molybdate +
Cobalt Oxide seed
treatment composition

| | Concentration |
|---|---|
| Component | (% wt/wt) |
| Molybdenum trioxide | 45.15 |
| Cobalt oxide | 3.00 |
| Kelzan AP-AS | 0.56 |
| Monoethanolamine | 18.39 |
| Water (deoinised) | 32.9 |
| Total | 100 |
| concentration | |

All sample compositions were applied at a rate of 30 gMo per 50 kg seed.

The calcium molybdate composition gave the best result. Of the three alternative gel formulations that contained cobalt, the monoethanolamine molybdate appeared to have the best compatibility with rhizobia when applied to seed in the in vivo assay.

TABLE 3
Viability of rhizobia over time
when applied to seed along for
tested sample compositions

| | Bacterial numbers | | | | |
|---|---|---|---|---|---|
| | log₁₀(CFU/mL) after | | | | |
| Sample | seed storage (days) for | | | | |
| Composition | 1 | 4 | 8 | 18 | 43 |
| Nitragin Optimize | 5.2 | 5.0 | 5.6 | 4.4 | <1.7 |
| (control) | | | | | |
| Calcium molybdate | 4.1 | 4.4 | 4.2 | 4.0 | <1.7 |
| (40%) SC | | | | | |
| Ammonium | 3.1 | 2.9 | <1.7 | <1.7 | <1.7 |
| molybdate + | | | | | |
| Cobalt Oxide Gel | | | | | |
| Sodium molybdate + | 3.9 | 3.7 | 3.0 | 2.9 | <1.7 |
| Cobalt Oxide Gel | | | | | |
| Monoethanolamine | 4.3 | 4.5 | 4.0 | 3.3 | 2.9 |
| molybdate + | | | | | |
| Cobalt Oxide Gel | | | | | |

### Study 4

Given that calcium molybdate appeared to have good compatibility in Study 3 this composition was selected for further studies. In Study 4 the calcium molybdate was reformulated to also include cobalt oxide. The composition utilised for Study 4 (detailed in Table 4) is described below:

Calcium molybdate +
Cobalt Oxide Composition

| | Concentration |
|---|---|
| Component | (% wt/wt) |
| Calcium molybdate | 38.97 |
| Tricobalt tetraoxide | 2.54 |
| Atlox PN100 | 4.55 |
| Atlox 4991 | 1.82 |
| Antifoam Gen | 0.03 |
| Kelzan AP-AS | 0.03 |
| Avicel CL611 | 0.35 |
| Water | 51.7 |
| Total | 100 |
| concentration (%) | |

The composition was compared at three different treat rates i) a high rate, 60 gMo (and 6 gCo) per 50 kg of seed, ii) a medium rate, 30 gMo (and 3 gCo) per 50 kg of seed, and iii) a low rate, 15 gMo (and 1.5 gCo) per 50 kg of seed. The inoculum was included at 1 mL/333 g seed.

The CFU counts for the calcium molybdate and cobalt oxide composition showed little loss of microbe viability when compared to the inoculant alone.

TABLE 4
Effect of CoMo
composition based on
calcium molybdate at three
rates on application to seed.

| | Bacterial numbers | | | |
|---|---|---|---|---|
| | log₁₀(CFU/mL) after | | | |
| Test | seed storage (days) for | | | |
| composition/salt | 1 | 4 | 9 | 29 |
| Nitragin Optimize | 5.87 | 5.94 | 5.84 | 3.98 |
| (control) | | | | |
| Calcium | 5.72 | 5.94 | 5.50 | 3.73 |
| molybdate + | | | | |
| Cobalt Oxide SC | | | | |
| high rate | | | | |
| Calcium | 5.90 | 5.91 | 5.38 | 3.89 |
| molybdate + | | | | |
| Cobalt Oxide SC | | | | |
| medium rate | | | | |
| Calcium | 5.93 | 6.08 | 5.69 | 3.91 |
| molybdate + | | | | |
| Cobalt Oxide | | | | |
| SC low rate | | | | |

### Study 5

In this study the composition described in Study 4, above, was tested again, however, this time a longer life inoculum was used (Nitragin Biopower) and the effects on rhizobium survival were assessed over a longer time period.

As in Study 4, the CFU counts for the calcium molybdate and cobalt oxide formulation were comparable to the inoculant only treatment demonstrating the exceptional compatibility of this composition with rhizobia.

TABLE 5
Effect of CoMo composition
based on calcium molybdate
on bacteria numbers over time
following application to seed.

| | Bacterial numbers | | | | |
|---|---|---|---|---|---|
| | log₁₀(CFU/mL) after | | | | |
| Test | seed storage (days) for | | | | |
| composition/salt | 1 | 15 | 29 | 45 | 59 |
| Nitragin Biopower | 5.66 | 4.95 | 4.44 | 3.39 | 2.98 |
| Calcium | 5.51 | 5.22 | 4.87 | 3.19 | 3.00 |
| molybdate + | | | | | |
| Cobalt Oxide SC | | | | | |

In summary, it has been found that calcium molybdate is a very safe compound with respect to Rhizobia compatibility and will allow for the use of a Co and/or Mo containing seed treatment product with long life Rhizobia without unduly negatively impacting the viability of Rhizobia on the treated seed.

1. A seed treatment composition comprising at least one inorganic molybdenum compound selected from potassium molybdate, magnesium molybdate and calcium molybdate, and one or more microbes.

2. The seed treatment composition according to claim 1, wherein the at least one inorganic molybdenum compound is selected from magnesium molybdate and calcium molybdate.

3. The seed treatment composition according to claim 1, wherein the seed treatment composition comprises calcium molybdate.

4. The seed treatment composition according to claim 1, wherein the seed treatment composition comprises between 0.1 wt % and 80 wt % molybdenum.

5. The seed treatment composition according to claim 1, wherein the one or more microbes is a plant growth promoting microbe.

6. The seed treatment composition according to claim 1, wherein one of the one or more microbes is a diazotrophic bacteria.

7. The seed treatment composition according to claim 6, wherein the diazotrophic bacteria is a rhizobacteria (rhizobia) and/or azospirillum.

8. The seed treatment composition according to claim 6, wherein the diazotrophic bacteria is a rhizobacteria.

9. The seed treatment composition according to claim 1, further comprising water.

10. The seed treatment composition according to claim 9, comprising between 25 wt % to 85 wt % water.

11. The seed treatment composition according to claim 1, further comprising cobalt.

12. The seed treatment composition according to claim 1, further comprising a binder.

13. The seed treatment composition according to claim 12, comprising up to 40 wt % binder.

14. The seed treatment composition according to claim 1, further comprising a dispersant.

15. The seed treatment composition according to claim 1, further comprising a wetting agent.

16. The seed treatment composition according to claim 15, comprising between 0 wt % and 5 wt % of a wetting agent.

17. The seed treatment composition according to claim 1, further comprising an antifoaming agent.

18. The seed treatment composition according to claim 17, comprising between 0.005 wt % to 10 wt % antifoaming agent.

19. The seed treatment composition according to claim 1, further comprising a viscosity modifier.

20. The seed treatment composition according to claim 19, comprising between 0.01 wt % to 2 wt % viscosity modifier.

21. The seed treatment composition according to claim 1, further comprising diluents, absorbents or carriers.

22. The seed treatment composition according to claim 1, which is free from antimicrobial agents and/or biocides.

23. A seed coated with the seed treatment composition according to claim 1.

24. The seed according to claim 23, wherein the seed is selected from the family of Fabaceae, commonly known as the legume family.

25. The seed according to claim 24, wherein the seed is selected from soybean, chickpea, pea, or alfalfa, and most preferably is soybean.

26. The seed according to claim 23, wherein the amount of seed treatment composition applied to the seed is in range of 0.05 to 20 mL per per kg seed.

27. A root treatment composition comprising the seed treatment composition according to claim 1.

28. A method of enhancing plant growth or crop production comprising applying the seed treatment composition according to claim 1 to a seed, soil, or a plant.
